(19) United States
(12) Patent Application Publication
(10) Pub. No.: US 2026/0367883 A1
(43) Pub. Date: Nov. 19, 2026

(54) EXECUTION-GUIDED WITHIN-PROMPT SEARCH WITH LARGE LANGUAGE MODELS

(71) Applicant: Microsoft Technology Licensing, LLC, Redmond, WA (US)

(72) Inventors: Sumit GULWANI, Sammamish, WA (US); Mukul SINGH, Seattle, WA (US); Ashish TIWARI, Sammamish, WA (US); Vu Minh LE, Redmond, WA (US); Gust Ben Anneloes VERBRUGGEN, Keerbergen (BE)

(73) Assignee: Microsoft Technology Licensing, LLC, Redmond, WA (US)

(21) Appl. No.: 19/210,959

(22) Filed: May 16, 2025

(51) Int. Cl. G06F 8/35

(52) U.S. Cl. CPC G06F 8/35

(57) ABSTRACT

Implementations for programming-by-example using a large language model (LLM) are provided. One example includes a computing system comprising: processing circuitry and memory storing instructions that cause the processing circuitry to perform the steps of: receiving a query for generating a program, wherein the query comprises example inputs and corresponding outputs; and generating the program using the LLM by: generating a prompt; refining the prompt by: generating a partial program with one or more initial lines of code; executing the one or more initial lines of code; storing, for each of the one or more initial lines of code, a text annotation; and autoregressively expanding the partial program by generating additional lines of code; and returning the partial program as the program when the partial program includes a function that returns a respective one of the example corresponding outputs for each of the example inputs.

### BACKGROUND

Programming-by-example refers to techniques for programming using a system that automatically infers a program that satisfies provided input-output examples, generally through inductive reasoning and search algorithms. Rather than manually writing code, a user can describe the desired behavior of the program by tailoring input-output examples accordingly. In addition to enhanced efficiency, programming-by-example techniques can lower the expertise barrier to programming by enabling users to express their intent through provided input-output examples rather than writing elaborate code adhering to complex syntactical rules.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Implementations for programming-by-example using a large language model are provided. One example includes a computing system comprising: processing circuitry and memory storing instructions that, during execution, cause the processing circuitry to perform the steps of: receiving a query for generating a program in a programming language, wherein the query comprises example inputs and corresponding outputs; and generating the program using the large language model by: generating a prompt that comprises the example inputs and the corresponding outputs; refining the prompt by: generating a partial program with one or more initial lines of code based on a syntax of the programming language; executing the one or more initial lines of code to extract a plurality of variable values, wherein each of the plurality of variable values corresponds to a respective one of the example inputs; storing, for each of the one or more initial lines of code, a text annotation describing the variable values for the example inputs; and autoregressively expanding the partial program by generating additional lines of code with corresponding text annotations in an iterative manner, wherein the additional lines of code are generated based on the syntax of the programming language, previously generated lines of code, and stored text annotations of the previously generated lines of code; and returning the partial program as the program when the partial program includes a function that returns a respective one of the example corresponding outputs for each of the example inputs.

### BRIEF DESCRIPTION OF THE DRAWINGS

FIG. 1 shows a schematic view of an example computing system for implementing programming-by-example with execution-guided within-prompt search using a large language model.

FIG. 2 shows a data flow diagram of an example method for implementing programming-by-example with an iterative process using a large language model, which can be implemented using the example computing system of FIG. 1.

FIG. 3 shows a data flow diagram of an example iteration loop of a method for implementing programming-by-example with execution-guided within-prompt search, which can be implemented using the example computing system of FIG. 1.

FIG. 4 shows a progression of an example prompt expansion of a method for implementing programming-by-example with execution-guided within-prompt search, which can be implemented using the example computing system of FIG. 1.

FIGS. 5 and 6 show graphs comparing performances of example setups for various programming-by-example methodologies across five benchmarks.

FIG. 7 shows a process flow diagram of an example method for implementing programming-by-example with execution-guided within-prompt search using a large language model, which can be implemented using the example computing system of FIG. 1.

FIG. 8 shows a process flow diagram of an example method for implementing an iterative prompt expansion process for programming-by-example with execution-guided within-prompt search, which can be implemented using the example computing system of FIG. 1.

FIG. 9 shows a schematic view of an example computing environment in which the computer system of FIG. 1 may be enacted.

### DETAILED DESCRIPTION

Automatically synthesizing code from a user-provided specification or any other form of intent is an area of great interest in the field of computer science. Many different approaches have been contemplated. One methodology includes programming-by-example (PBE) where a synthesizer is tasked to generate code that satisfies a provided specification containing a set of inputs and corresponding expected outputs. Generally, the synthesizer attempts to detect a pattern between the inputs and the corresponding outputs and write code that performs a transformation corresponding to the detected pattern. Such a synthesizer can be implemented in various ways. Some methods make use of large language models (LLMs) to generate code from a specification of input-output examples and/or a problem statement. Such LLMs are typically trained to recognize patterns in text to predict additional text. The LLMs implemented for PBE to generate code are often trained using data containing significant amounts of code and examples of how to use that code, such as through tutorials and unit tests.

There are many challenges with utilizing LLMs for PBE. Some methodologies task the LLMs to generate code from examples without being limited to a domain-specific language (DSL). Such methods usually lack soundness guarantees. In the context of PBE, soundness describes a program that is correct for a given set of input-output examples. Although code output by such methods may look correct to the LLM (and maybe also to a human user), it may not be correct for all inputs. Oftentimes, such methodologies lack guarantees that the code will execute properly. Another issue includes circumstances when the patterns between the example input-output pairs are more complicated. In such cases, the LLM can often fail. One reason is that the model tends to overfit on a dominant or more common pattern in the assertions. The model generally considers the syntactic space rather than reasoning about the semantics of the program. Generally, naively sampling tokens in an iterative manner does not allow the model to reconsider or search through earlier code like a human programmer would do.

In view of the observations above, implementations of programming-by-example techniques utilizing execution-guided within-prompt search with large language models are provided. An LLM can be implemented as a policy that generates or predicts lines of code. Generated code can be added to expand upon a single prompt in iterative cycles. Traditional processes utilizing LLMs typically include a generation structure that is (human, model), where tokens are provided by a human and the model generates tokens in response. In contrast to the generation structure of (human, model), the iterative processes described herein can be implemented in a generation structure of (human, model, human, model, human, model, . . . ), where the first (human) is the original problem statement and each subsequent (human) part updates the prompt before asking for the next few tokens. Although referred to as human-provided tokens, such tokens may be provided automatically by the system. For example, subsequent (human) parts may be fed back to the model automatically. Semantically, this can also be referred to as a (human, model, model, model, . . . ) structure where subsequent “model” calls rely on the output of the previous “model” call. For example, each “model” call can return a plurality of candidate outputs. A subsequent “model” call may select one of the candidate outputs for further exploration.

In some implementations, multiple lines of code are generated at each iteration and combined into the prompt. The LLM can implicitly estimate the value of each line of code to generate further code in a next iteration to expand the prompt. The policy and value estimation can be guided using various techniques to provide efficient prompt expansion. In some implementations, additional code is generated from one or more previous lines of code in the current prompt. The LLM can choose which line of code to continue from for the generation of code in a next iteration. This can be implemented using a tree-like search process that tracks and explores multiple branches within a single prompt. For the purposes of this disclosure, such search processes are referred to as “within-prompt search” (“WPS”) as one prompt contains all the states that have been explored. In some implementations, the search is conditioned on natural language. WPS can be applied to other domains where the final solution can be broken down into a series of steps. WPS can also be expanded to code generation without soundness check by having an explicit stop token (e.g., a return statement). This enables WPS to be applied to any LLM application that involves some form of code-based planning.

Additionally or alternatively to WPS, prompt expansion can be execution-guided where each line of generated code is executed with the example inputs to generate executed results, which can be injected back into the prompt. For example, the results can be stored as annotations (e.g., comments) to corresponding lines of code. This enables the policy to reason in both the syntactic (code) and semantic (execution) space to efficiently search for programs within a single, expanding LLM prompt until a sound program is found or until a predetermined number of iterations is reached. In addition to these processes, various other techniques such as but not limited to de-duplication and canonicalization can be applied to provide further efficiency.

The iterative PBE processes described herein include prompt expansion techniques that offer several technical advantages. Generally, the techniques described herein are more token-efficient compared to current methodologies, including but not limited to other search-based prompt methodologies. For example, in tree-of-thought search, each different generation is scored explicitly with a second prompt. In contrast, WPS can implicitly score all elements or choices for the model to choose the path from which to continue. WPS can also be more efficient than self-debugging methods. Rather than generating whole programs, executing them, and then providing feedback to the model, WPS enables immediate feedback after each line of code. WPS also allows for a search without needing to specify a DSL. Other search-based approaches generally perform a search over an explicitly defined search program space. In contrast, WPS can be applied to any programming language by leveraging the LLM's power to generate code in that language.

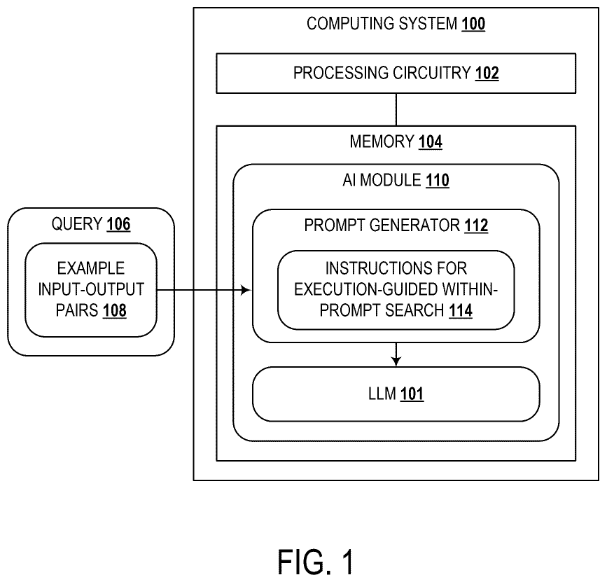

Turning now to the drawings, implementations of programming-by-example techniques utilizing execution-guided within-prompt search with large language models are depicted and described in further detail. FIG. 1 shows a schematic view of an example computing system 100 for implementing programming-by-example with execution-guided within-prompt search using a large language model 101. The example computing system 100 includes processing circuitry 102 and memory 104 storing instructions that, during execution, cause the processing circuitry 102 to perform the processes described herein. The example computing system 100 can be implemented with one or more of various types of computing devices, including but not limited to personal computers, servers, and mobile devices. For example, the computing system 100 can include a plurality of computing devices, and processing circuitry 102 and memory 104 may each include multiple components spread across multiple computing devices (e.g., processing circuitry 102 can include multiple processors within a single device or spread across multiple devices). The devices may be locally and/or remotely located. The example computing system 100 can also include non-depicted components for providing various functionalities, including components on individual computing devices.

The PBE process starts with receiving a query 106 that includes a request containing a problem statement and/or a specification for generating a program. In some implementations, the query 106 specifies a programming language in which the program is to be generated. Any programming language can be specified. Advantageously, the PBE process utilizes an LLM 101 that has been trained to generate code in the specified programming language. For example, if the query 106 includes a request to generate a program in the Python programming language (developed by the Python Software Foundation headquartered in Wilmington, Delaware), the PBE process can advantageously utilize an LLM 101 that has been trained on training data containing Python code and relevant examples, tutorials, and/or instructions. In other implementations, the query 106 does not specify a programming language. For example, the user may be aware that the PBE LLM system is configured to generate programs in a preset programming language.

In the depicted example of FIG. 1, the query 106 includes a set of example input-output pairs 108 as a specification for generating the program. In some implementations, the query 106 may include further information for generating the program, such as guidance and/or constraints. Generally, the PBE process is tasked to generate a sound program that satisfies the example input-output pairs 108—i.e., the program correctly returns a corresponding output for each of the inputs. Mathematically, the PBE process can be described as follows: given n input-output examples

$$E = {\{ ( {x}_{i} , {y}_{i} ) \}}_{i = 1}^{n} ,$$

the goal of PBE is to find a program P such that P(xᵢ)=yᵢ for all i. In some implementations, a subset of examples E_{g}⊂E is given. The program P is sound (P [symbol] E_{g}) if P(xᵢ)=yᵢ for all (xᵢ, yᵢ)∈E_{g}.

The computing system 100 can receive the query 106 in various ways. In some implementations, the computing system 100 is a device operated locally by a user that provides the query 106 as a direct input. In other implementations, the computer system 100 is remote from the user, and the provided query 106 is transmitted through a communication system (e.g., the Internet). For example, the query 106 can be provided to a local computing device, which then transmits the query 106 to the computing system 100.

The computing system 100 includes an AI module 110 that receives the query 106. The AI module 110 includes various components for answering the query 106 using PBE. In the depicted example, the AI module 110 includes a prompt generator 112 and the LLM 101. The prompt generator 112 takes the query 106 and generates a corresponding prompt that can be fed into the LLM 101 to generate the program. For example, the prompt generator 112 can take the example input-output pairs 108 and inject them into a prompt that tasks the LLM 101 to generate a sound program with respect to the example input-output pairs 108. In some implementations, the query 106 includes a request to generate the program in a given programming language, and the prompt generator 112 generates a prompt containing instructions to do so.

Various PBE processes can be implemented to generate a sound program based on the example input-output pairs 108. In some implementations, the prompt generator 112 generates a prompt containing instructions tasking the LLM 101 to generate a program by iteratively generating code, expanding the prompt until a sound program is found within the generated code. Prompt expansion can be performed in various ways. As described in the sections above, PBE processes can perform code generation and prompt expansion using various techniques for guidance. For example, execution-guided and/or within-prompt search techniques can be implemented. In the depicted example, the prompt generator 112 includes components for injecting instructions 114 for performing execution-guided within-prompt search techniques into the generated prompt.

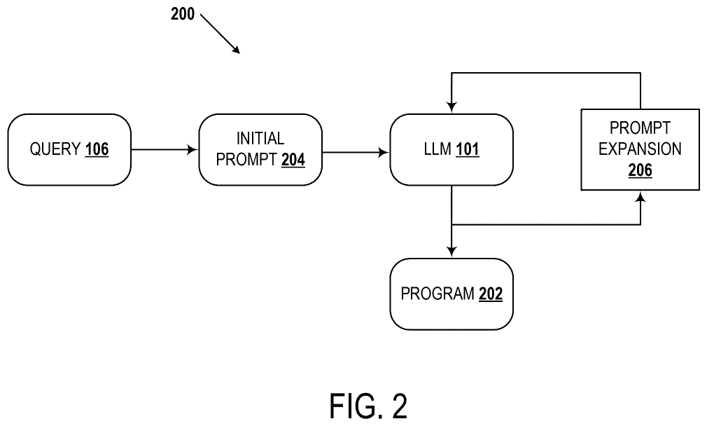

Turning now to FIG. 2, a data flow diagram of an example method 200 for implementing programming-by-example with an iterative process using a large language model 101 is shown. The example method 200 starts with receiving a query 106 containing a request to generate a program 202. The query 106 can generally include a specification describing the program 202 that a user wishes to generate. In some implementations, the query 106 includes a set of example input-output pairs that can guide the generation of the program 202. The query 106 can also include a request to generate the program 202 in a specified programming language.

An initial prompt 204 is generated based on the query 106. For example, if the query 106 includes a set of input-output examples as a specification, such information can be included in the initial prompt 204. The initial prompt 204 may include any other information provided by the query 106, such as additional constraints and/or guidance on generation of the program 202. In some implementations, the initial prompt 204 includes an instruction, a static example, a set of assertions on a function, and the function itself. In further implementations, the instruction instructs the LLM to generate code without control flow statements and that any function from the standard library can be used. The instruction can also instruct the LLM to use variables as a scratchpad and to create a comment each time a new variable is initialized. In some implementations, the static example contains at least one line of code that is not needed.

The initial prompt 204 is fed into the LLM 101, which then performs a PBE process to generate the program 202 based on the initial prompt 204. In the depicted example, the LLM 101 performs the PBE process through a prompt expansion loop 206 that is performed in an iterative manner where the prompt is refined through each iteration. The iterative process can be repeated until a sound program 202 that satisfies the query 106 is found or until a predetermined number of iterations has been reached.

The prompt expansion step 206 can be performed in various ways. In some implementations, the prompt 204 is expanded in an autoregressive manner where each expansion step is based on the current state of the prompt. Generally, the prompt expansion loop 206 includes generating code at each iteration based on code in the current prompt. The PBE process can generate code in various ways. In some implementations, one or more operations are sampled from a library of available operations or functions for a given programming language. The LLM 101 can be trained on such knowledge, or the LLM 101 may have access to the library. Generated code can be injected back into the prompt, expanding it for the next iteration. In some implementations, de-duplication and/or canonicalization is performed on the generated code to remove redundancy before the generated code is added back into the prompt. At the next iteration, additional code can be generated based on the expanded prompt, which includes all the previously-generated code. For example, additional lines of code can be generated to include operations and variables from previously-generated lines of code. In some implementations, the PBE process includes eliminating code from the prompt. For example, lines that have not been utilized for the generation of additional code within a predetermined number of iterations can be removed from the prompt. Reducing unnecessary text from the prompt may provide more efficient runtimes.

Code generation at each iteration in the prompt expansion loop 206 can be guided using various techniques. For example, the generation of code at each iteration can be execution-guided and/or guided through WPS. The LLM 101 can be implemented as both the (explicit) policy and (implicit) value network to search for code. In some implementations, the LLM 101 searches for code in a bottom-up way. Consider a function P(x)=[o₁, . . . , oₙ] where each operation oᵢ(o_{<i}, x) is a function of the outputs of the previous operations o_{<i} and the input x that returns a single value (denoted as oᵢ). The value of oₙ is the return value. An operation can be drawn from the grammar of any programming language.

Encoding the specification given by E_{g} and a partial program Pⱼ=[o₁, . . . , oⱼ] in a prompt, the PBE process can include sampling a new operation oⱼ₊₁~pLLM(⋅|E_{g}, Pⱼ, t) from the LLM 101 with t as the sampling temperature. If the temperature is set to 0, the LLM 101 acts as a deterministic policy that maps each state (E_{g}, Pⱼ) to its most likely next operation oⱼ₊₁. For higher temperatures, the LLM 101 acts as a stochastic policy that maps (E_{g}, Pⱼ) to a distribution of operations.

Instead of a learned policy π, the LLM 101 is prompted to find arg maxₒ_{ⱼ}_{~π}[Q^{π}(oⱼ, Pⱼ₋₁)] where the value Q^{π}(oⱼ, Pⱼ₋₁) of considering an operation oⱼ in program Pⱼ₋₁ is the expectation that it can be completed into a valid program, or Q(oⱼ, Pⱼ₋₁)=E_{P}_{_{τ}}_{~π}[Pⱼ₋₁∘oⱼ∘P_{τ} [symbol] E_{g}] where P_{τ} is a sequence of operations sampled from the (prompted) policy and where ∘ denotes operation concatenation.

In some implementations, one line of code is generated at each iteration of the prompt expansion loop 206. In other implementations, multiple lines of code are generated and added to the prompt at each iteration. As described in the sections above, de-duplication and/or canonicalization can be performed. In some implementations, k operations

$${O}_{j + 1} = \{ {o}_{j + 1}^{1} , … , {o}_{j + 1}^{k} \}$$

are sampled from the LLM with t>0. Instead of heuristically picking one operation

$${o}_{j + 1}^{*} ∈ {O}_{j + 1}$$

to extend Pⱼ before sampling the next operation, the process can set P_{j+k′}=ƒ_{C}(Pⱼ∘Oⱼ₊₁) with k′≤k, where ∘ denotes operation concatenation). The LLM 101 can act as that heuristic in the next iteration. Here, ƒ_{C} is a combination function that de-duplicates and/or canonicalizes the given operations, resulting in a potential subset k′ of the k new operations to be added.

Instead of a single program, Pⱼ then represents all programs explored in all iterations ≤j, where each operation can be considered as its own root node. When writing an operation oⱼ₊₁, the LLM 101 selects one or more nodes oᵢ∈Pⱼ from which to continue. For example, the LLM 101 can perform WPS to select operations that are expected to lead to a correct program by implicitly considering V^{π}(oᵢ)=E_{o~π}[Q^{π}(o, Pᵢ)] to estimate the expected value of each operation oᵢ∈Pⱼ. The search happens within one prompt that is iteratively extended.

Sampling multiple operations Oⱼ and combining them into a new state (E_{g}, Pⱼ₊₁, [symbol] Oⱼ₊₁ [symbol] ) allows the LLM 101 to perform a within-prompt search. Each state (program) in the search is combined into a single superstate, which the LLM 101 can expand. The search may terminate when oₗ [symbol] E_{g} for any oₗ∈Pⱼ. Operations that are not used by or removed, and the program 202 is returned. In theory, the state can be expanded until the context window of the LLM 101 is reached, and implicit backtracking can be utilized wherein the (implicit) value function ignores operations that cannot lead to a valid program. In practice, the process can be implemented to explicitly backtrack by, for example, pruning operations o∈Oⱼ that are not used in any of the k most recent iterations [Oⱼ₋ₖ, . . . , Oⱼ].

In some implementations, the LLM 101 is used as an explicit value function by using a separate prompt to rank each

$${o}_{j + 1}^{i} ∈ {O}_{j + 1}$$

and getting k next states

$${P}_{j + 1}^{i} = {P}_{j} ∘ {o}_{j + 1}^{i}$$

that can be explicitly searched over based on their value. This corresponds to tree-of-thought techniques with lines of code corresponding to thought decompositions, the policy corresponding to the thought generator, and the value prompt being the state evaluator.

The prompt expansion process can be execution-guided where code is executed, and the execution results are injected back into the prompt to guide the LLM 101 towards better predictions. Understanding the execution semantics of Pⱼ is a factor when deciding on a next operation oⱼ₊₁, especially since the specification E_{g} is in this semantic space. Executing code [symbol] Pⱼ [symbol] ={P(x)|x∈E_{g}} on the given examples E_{g} and conditioning the policy and value on ( [symbol] Pⱼ [symbol] , E_{g}) instead of (Pⱼ, E_{g}) allows the process to make better decisions in the semantic (execution) space. This can be analogous to a human developer using code printing statements to evaluate their progress so far and to then make decisions based on that progress. LLMs have strong code understanding capabilities, allowing them to make decisions based on both the semantic and syntactic representation of Pⱼ. Instead of only the final output [symbol] Pⱼ [symbol] , the value of each operation o∈Pⱼ can be obtained on the given examples. As such, [symbol] Oⱼ [symbol] ={{o(x)|x∈E_{g}}|o∈Oⱼ} can be added to the condition of the policy (i.e., added to the prompt).

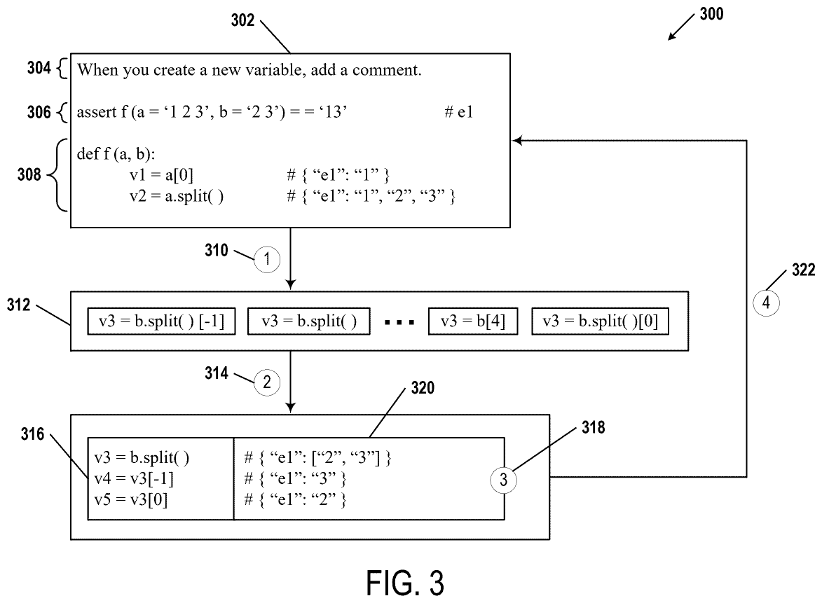

FIG. 3 shows a data flow diagram of an example iteration loop 300 of a method for implementing programming-by-example with execution-guided within-prompt search. The iteration loop 300 can be, for example, a loop of the prompt expansion process 206 of FIG. 2. The loop 300 begins with a prompt 302. In the depicted example, code is generated in discrete lines where each line introduces a new variable that is assigned a value based on an operation applied to an example input and/or one or more variables created in one or more previous lines of code. In the depicted example, the prompt 302 includes an instruction 304 for adding a comment when a new variable is created, an assertion 306 on a function (describing an example input-output pair that the program is to satisfy), and the current function 308 itself.

At a first step 310, the LLM predicts production rules in the grammar of a given programming language (e.g., Python in the depicted example) and thus acts as a policy π. The LLM generates a set of statements 312 that correspond to operations sampled from available operations in the given programming language. The set of statements 312 is generated as candidates for additional lines of code. In some implementations, the LLM is instructed to generate each statement on a single line. In such cases, a single operation can be sampled by using the newline character “\n” as a stopping token. Operations that do not parse or execute can be skipped.

In the depicted example, the current function 308 encoded in the current prompt 302 includes two lines of code that correspond to variables “v1” and “v2”, respectively. In the depicted example, each line is initialized with a variable starting with “v” to ensure that the LLM generates a straight-line program with variables (v1, v2, . . . ) as the model tokenizes digits separately—i.e., “v1” is always broken down into “v” and “1”.

At a second step 314, the statements 312 are combined, de-duplicated, and canonicalized, which enables the LLM to function as a value predictor. After ensuring that each generated line of code assigns its value to a unique variable, the lines of code can be concatenated, and global canonicalization steps can be performed. In some implementations, the comparisons are made on the abstract syntax tree (AST) level. For example, duplicated statements can be removed (e.g., identical operations, identical execution results, etc.). Statements containing terms that can be reduced and/or substituted with an existing variable can be simplified accordingly. As a result, new lines of code 316 are generated and are designated to be added back into the prompt 302.

At a third step 318, the code 316 is executed. Generally, the code 316 is executed with the input example(s) described in the assertions 306 of the prompt 302. For each input example, a corresponding executed result is generated. The executed values are then extracted and added as comments 318. In the depicted example, there is only one input example, designated with the identifier “e1”. Accordingly, each line of comment contains one executed value. In cases with more than one example, each would be designated with a unique identifier. This enables the process to anchor the execution result of each operation v=r(x) onto that identifier in a dictionary by mapping {“e1”:r(x1)}. As such, for each example, an executed value is included in the annotations, mapped to its corresponding example input. For the purposes of this disclosure, “executed value” refers to an output of an executed line of code. Depending on the statement, the executed value may include multiple data elements, which can be of the same or different data types/data structures. For example, in the depicted example, the comment corresponding to the variable “v3” includes an executed result of a list containing two data elements.

At a fourth step 322, the prompt 302 is extended with the newly generated code 316 and its accompanying comments 318 describing the executed results for the input example. The process can then loop again with the expanded prompt. Termination of the process can be defined in various ways. Generally, the process will terminate when a function that satisfies the assertion 306 is found—i.e., when any of the variable results matches the assertions. For example, when a line of generated code is executed and the executed value matches the output value in the assertion 306, the iterative process can terminate. Upon termination, the code that returns the correct output is provided as the program. In some implementations, lines of code that are not used by the terminating line of code are removed, and the function 308 is returned. In some implementations, the iterative process terminates upon reaching a predetermined number of iterations, regardless of whether a sound program is found.

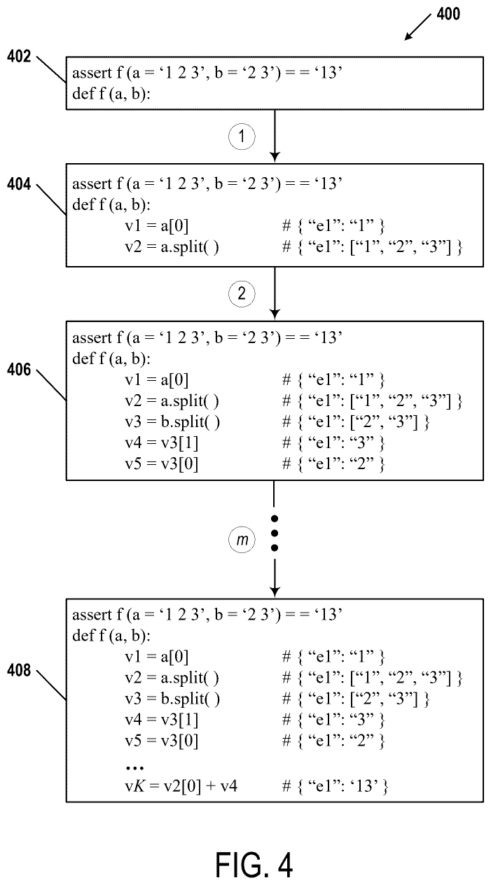

FIG. 4 shows a progression of an example prompt expansion 400 of a method for implementing programming-by-example with execution-guided within-prompt search. At the start, the initial prompt 402 includes specification E_{g}, which includes an example (e1) described in assertion (ƒ(a=‘1 2 3’, b=‘2 3’)==‘13’), and initializes a program P (function ƒ(a, b)). In other words, the prompt 402 is tasking the LLM to find a function (program) that takes two inputs (a and b). Based on the specification E_{g}, the function also has to return the value ‘13’ given an input of {‘1 2 3’,‘2 3’}.

After a first iteration, the prompt 404 includes program P₂ containing two lines of code, respectively corresponding to variables “v1” and “v2”. In some implementations, each iteration adds a predetermined number of lines of code. In the depicted example, a predetermined number k of operations are sampled. After the candidate operations are combined, de-duplicated, and canonicalized, the remaining operations are added to the prompt. In the case of the first iteration, two operations are added. Specifically, the first line of code assigns the variable “v1” to the value of the first element of the input (a) of the function ƒ(a, b). The second line of code assigns the variable “v2” to the value of the performing a split( ) operation on input (a) of the function ƒ(a, b).

Before sampling new operations in a next iteration, the program is executed, and each line of code (operation) is annotated with its output on the given input (e1) to allow reasoning about both the syntax (code) and semantics (output) of the current states. The execution of these two lines of code in accordance with example input (e1) returns a value of “1” and [“1”, “2”, “3”], respectively. For this and other iterations, the value function can decide which state to continue from in the next iteration. Instead of keeping track of different states, the “search” includes a single prompt (superstate) that is iteratively expanded. Before sampling new operations in a next iteration, the program P₂ is executed, and each line of code (operation) is annotated with its output on the given input (e1) to allow reasoning about both the syntax (code) and semantics (output) of the current states.

After a second iteration, the prompt 406 includes program P₅ containing five lines of code. In the depicted example, three lines of code corresponding to variables “v3”, “v4”, and “v5” are added to the program. These three lines of code can be derived in various ways. In the depicted example, the LLM samples operations and generates new statements

$$\{ {o}_{3}^{1} = b \cdot split ( ) [ 1 ] , {o}_{3}^{2} = b \cdot split ( ) , {o}_{3}^{3} = b [ 4 ] , {o}_{3}^{4} = b \cdot split ( ) [ 0 ] \} .$$

### Since

$${o}_{3}^{3}$$

does not execute, it is removed. Operation

$${o}_{3}^{2}$$

is a subprogram of

$${o}_{3}^{1} and {o}_{3}^{4}$$

and the substitution

$${o}_{3}^{1} = {o}_{3}^{2} \cdot split ( ) [ 1 ] and {o}_{3}^{4} = {o}_{3}^{2} \cdot split ( ) [ 0 ]$$

is made by ƒ_{C}, a function that de-duplicates and canonicalizes the given operations. The program P₅ is then executed, and each line of code is annotated with its output on the given input (e1).

After m iterations, the prompt 406 includes program P_{K} containing K lines of code. In the depicted example, the Kth line of code is executed according to the specification E_{g} and returns the correct output of ‘13’ (as described in the assertion f(a=‘1 2 3’, b=‘2 3’)==‘13’)). More specifically, the Kth line of code assigns the variable “vK” to the value of (v2[0]+v4), which ultimately concatenates the first element of input (a=‘1 2 3’) with the second element of input (b=‘2 3’). As the assertion is satisfied by the Kth line of code, a sound program is found. In some implementations, lines that are not used by the Kth line of code are removed before the program P_{K} is returned as an answer to the query. In the depicted example, the Kth line of code utilizes variables from the second, third, and fourth lines of code. As such, every other line can be removed.

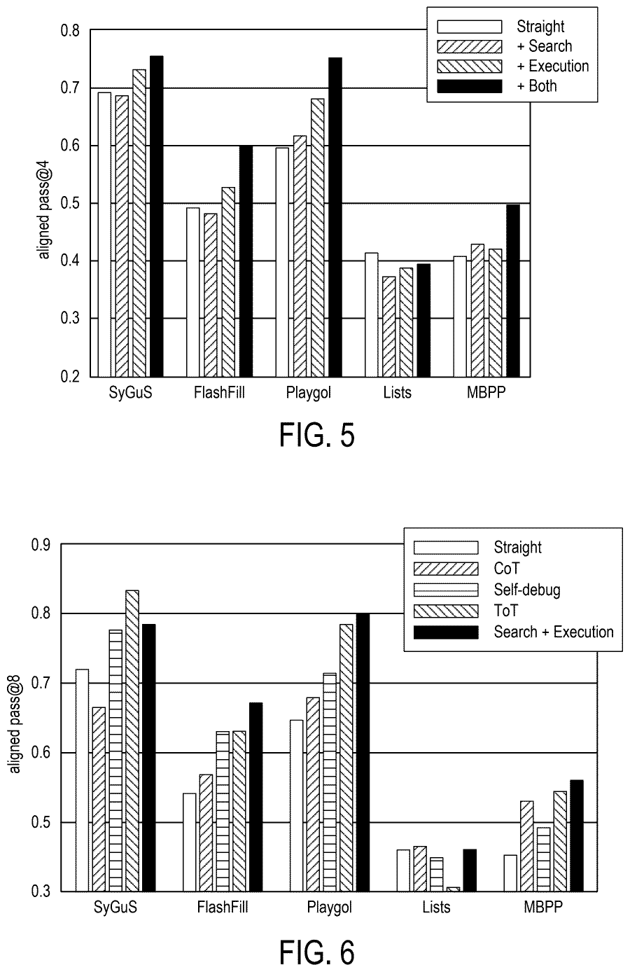

FIGS. 5 and 6 show graphs comparing performances of example setups for various programming-by-example methodologies across five benchmarks. The five benchmarks are well known datasets in the field and include SyGuS, FlashFill (PROSE) Playgol, Lists, and MBPP. The datasets span different domains, including nontrivial problems (no empty values, three or more examples), string transformation, inductive logic programming, list understanding problems, and basic Python problems. FIG. 5 shows a graph comparing a baseline straight-line code generation methodology, a within-prompt search methodology, an execution-guided methodology, and an execution-guided within-prompt search methodology for the five benchmarks. FIG. 6 shows a graph comparing a baseline straight-line code generation methodology, a chain-of-thought (CoT) methodology, a self-debug methodology, a tree-of-thought (ToT) methodology, and an execution-guided within-prompt search methodology for the five benchmarks.

A straight methodology directly asks the model to generate the code. A chain-of-thought methodology asks the model to first explain its thoughts and then generate code. This does not use any execution feedback or search. The self-debug methodology executes the code on the examples and iteratively asks the model to refine based on the outcome. When an exception is thrown, only exceptions are included in the subsequent prompt to the model. When no exception is thrown, all wrong outputs are reported to the model as ƒ(x)=y′ (expected y). Only the last iteration is shown to the model. As such, in the self-debug methodology, any prompt in iteration i>1 is structured as [system, user₁, assistantᵢ₋₁, userᵢ₋₁] with assistantᵢ₋₁ program after i−1 iterations and userᵢ₋₁ the feedback on that program. Eight iterations were used. The tree-of-thought methodology uses an explicit value prompt to perform a search. As opposed to WPS, this performs an outside-prompt search. The value prompt asks the model to reason about each line (including its execution) and to rate it. Nodes are scored by the value of their last line first and depth second, meaning that the search backjumps to the last unexplored node in which the last line has the highest score.

Unless specified otherwise, a k of four operations are sampled at each line at a temperature of 0.6. Generally, in most settings, the performance improves with k. In the example setup, a maximum number of iterations was set to eight. Pass@k metrics (the probability that at least one out of k samples is correct) are used for performance comparisons. Because each method implicitly generates a different number of programs to arrive at one completion, the aligned pass@8 rate is computed. For example, straight only generates one program per completion, but within-prompt search generates four programs with k=4, so we compare their pass@4 and pass@1 rates, respectively. This corresponds to using a generate-and-test strategy for cheaper methods until the same budget is reached. T budget is set to eight, and the metrics are aligned as follows: Straight: pass@8 over thirty-two completions; CoT: pass@4 (the thought counts as one program, despite consuming significantly more tokens) over sixteen completions; self-debug: pass@1 repeated over four folds; ToT: pass@1 (the value prompt counts as one program as it includes reasoning) repeated over three folds; and WPS: pass@2 repeated over four folds.

FIG. 5 shows the aligned pass@4 rate of straight-line code generation with search, execution, and both. Execution without search is performed at k=1 with temperature 0 and is thus deterministic (pass@1). As shown, without execution, the implicit value function does not help the model select better completions, and the performance is similar to straight-line code generation. With execution and search, within-prompt search (pass@1) allows the model to perform better than the generate-and-test strategy (pass@4) in four out of five benchmarks. On the Lists benchmark, where the problem statement is less clear from looking at the examples, generating candidates as a single program is more effective than trying to reason about the intermediate values.

FIG. 6 shows the aligned pass@8 rate of straight-line code generation, CoT, self-debug, ToT, and WPS. As shown, WPS is either the best (⅗) or second-best (⅖) generation strategy. SyGus has a set of similar problems with long strings where different variations of splitting are generated in the first iteration, which results in many small value tokens that confuse WPS. By reasoning about which is the correct split, ToT performs better at these. Conversely, on Lists, it is often less clear what the problem is, and either trying different things (WPS) or getting directed, end-to-end feedback (self-debug) perform better. Thinking about the problem (CoT) or a generate-and-test strategy (straight) is also effective.

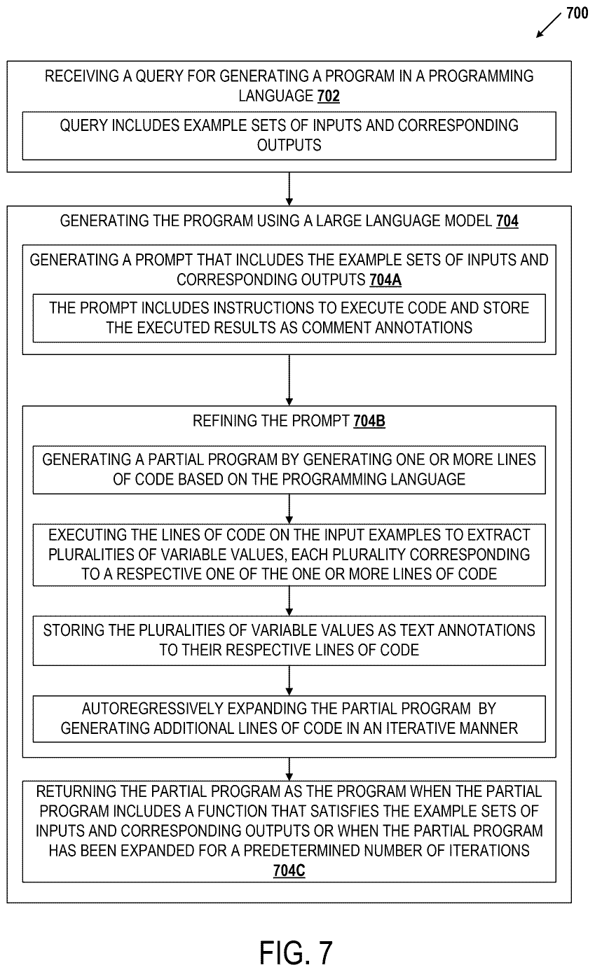

FIG. 7 shows a process flow diagram of an example method 700 for implementing programming-by-example with execution-guided within-prompt search using a large language model. The example method 700 includes, at step 702, receiving a query for generating a program. The query can include a request containing a problem statement and/or a specification for generating a program. In some implementations, the query includes a specification containing sets of example inputs and their corresponding outputs. The query can also specify a programming language in which the program is to be generated. Any programming language can be specified.

The example method 700 includes, at step 704, generating the program using a large language model. Various types of LLMs can be utilized. In some implementations, the method 700 utilizes an LLM that has been trained to generate code in a given programming language. For example, the LLM can be trained to generate code in a programming language specified in the query. The LLM can generate the program in various ways. Substeps 704A-704C describe an example process for generating a sound program with respect to the specification in the received query.

At substep 704A, the process includes generating a prompt that includes the example sets of inputs and corresponding outputs. The prompt can include instructions that task the LLM to generate a sound program with respect to the example input-output pairs. In some implementations, the prompt includes instructions to execute generated code and to store the results as comments or annotations within the prompt. The prompt may also include an initialized function in which code for the program can be built in an iterative manner.

At substep 704B, the process includes refining the prompt. Refining the prompt can include first generating a partial program by generating an initial set of one or more lines of code. For example, the prompt can include an initialized empty function, and the initial set of one or more lines of code can be generated and injected into said function. The initial set of one or more lines of code can be generated based on the programming language. For example, the LLM can generate lines of code with operations adhering to the syntax of the given programming language. Any type of programming language can be implemented. As described in the sections above, the programming language can be one for which the LLM has been trained to generate code.

Refining the prompt can further include executing the one or more lines of code to extract pluralities of variable values. Each plurality of the pluralities of variable values corresponds to a respective line of code, and each variable value in a plurality of variable values corresponds to a respective input example for the respective line of code. Each plurality of the pluralities of variable values can then be stored as text annotations or comments to the respective line of code, and each variable value can be mapped to the unique identifier of the respective input example.

Refining the prompt can further include autoregressively expanding the partial program. In some implementations, the partial program is expanded in an iterative process that generates code at each iteration. Prompt expansion can be performed in various ways. In some implementations, the prompt is expanded in an autoregressive manner. At each iteration, lines of code can be generated based on the current prompt (current code in the function in the prompt). For example, additional lines of code for a given iteration can be generated based on the syntax of the programming language, previously generated lines of code, and stored text annotations of the previously generated lines of code. The LLM can generate multiple statements or lines of code at a given iteration. In some implementations, de-duplication and/or canonicalization is performed on the generated lines of code. Generated code can be injected back into the prompt, and additional code can be generated at the next iteration based on the expanded prompt. In some implementations, refining the prompt includes removing lines of code. For example, lines of code that have not been utilized for the generation of additional code can be removed after a predetermined number of iterations.

At substep 704C, the process includes returning the partial program as the program when the partial program includes a function that satisfies the example sets of inputs and corresponding outputs from the query. In some implementations, lines of code that are not used in the function to satisfy the example sets of inputs and corresponding outputs from the query can be removed before the program is returned. The prompt expansion process can also be configured to terminate after a predetermined number of iterations have been performed without finding a sound program.

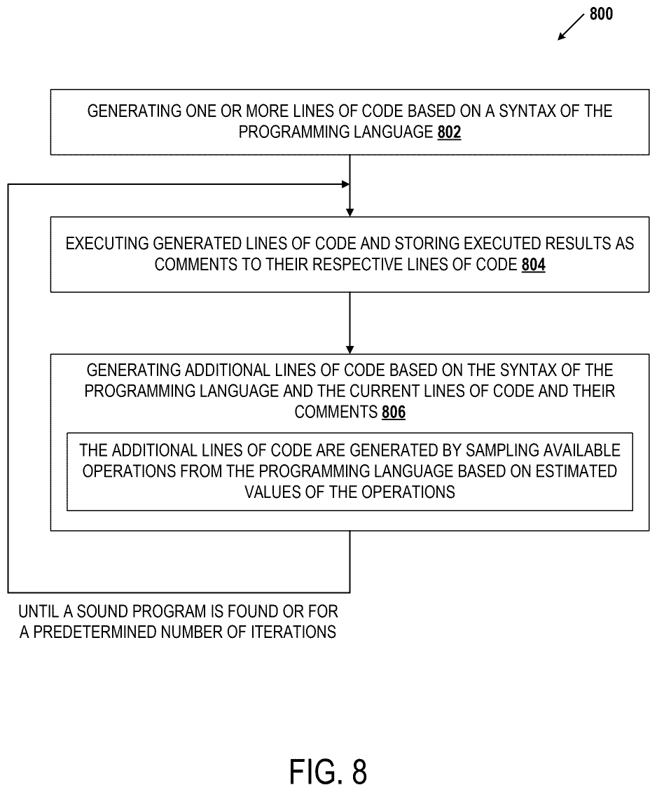

FIG. 8 shows a process flow diagram of an example method for implementing an iterative prompt expansion process for programming-by-example with execution-guided within-prompt search. The example method 800 includes, at step 802, generating one or more lines of code based on a syntax of the programming language. Code can be generated in various ways. In some implementations, one or more operations are sampled from a library of available operations or functions for a given programming language.

The example method 800 includes, at step 804, executing generated lines of code and storing executed results as comments to their respective lines of code. For example, the lines of code generated in step 802 can be executed based on provided example inputs. For each input, a separate executed value can be extracted and used for annotating the corresponding line of code. The annotation can map a unique identifier of the example input to the corresponding executed value.

The example method 800 includes, at step 806, generating additional lines of code based on the syntax of the programming language and the current lines of code and their comments. The additional lines of code can be generated in various ways. In some implementations, the additional lines of code are generated by sampling available operations from the programming language based on estimated values of the operations. The LLM can perform a within-prompt search to determine which line of code to continue from for the generation of additional lines of code. For example, an additional line of code can be generated from a sampled operation that is performed on a variable defined in a previously-generated line of code. Additionally or alternatively, the LLM can utilize the comments/annotations of the lines of code to guide the generation of the additional lines of code. For example, the annotations/comments can guide the LLM in determining which line of code to continue from for the generation of additional lines of code based on estimated values of the lines of code.

Steps 804 and 806 can be repeated in an iterative manner. For example, the additional lines of code generated in step 806 can be executed, and their executed values can be extracted and stored as annotations to the corresponding lines of code. The iterative loops can be repeated until a sound program is found or until a predetermined number of iterations has been reached.

In some embodiments, the methods and processes described herein may be tied to a computing system of one or more computing devices. In particular, such methods and processes may be implemented as a computer-application program or service, an application-programming interface (API), a library, and/or other computer-program product.

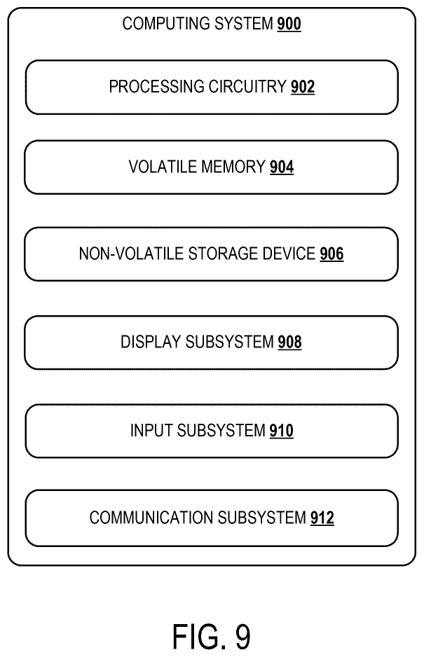

FIG. 9 schematically shows a non-limiting embodiment of a computing system 900 that can enact one or more of the methods and processes described above. Computing system 900 is shown in simplified form. Computing system 900 may embody the computing system 100 described above and illustrated in FIG. 1. Components of computing system 900 may be included in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 900 includes processing circuitry 902, volatile memory 904, and a non-volatile storage device 906. Computing system 900 may optionally include a display subsystem 908, input subsystem 910, communication subsystem 912, and/or other components not shown in FIG. 9.

Processing circuitry 902 includes a logic processor that can be implemented with one or more physical devices configured to execute instructions. For example, the processing circuitry 902 may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The processing circuitry 902 may include one or more physical processors configured to execute software instructions. Additionally or alternatively, the processing circuitry 902 may include one or more hardware logic circuits or firmware devices configured to execute hardware-implemented logic or firmware instructions. Processors of the processing circuitry 902 may be single-core or multi-core, and the instructions executed thereon may be configured for sequential, parallel, and/or distributed processing. Individual components of the processing circuitry 902 optionally may be distributed among two or more separate devices, which may be remotely located and/or configured for coordinated processing. Aspects of the processing circuitry 902 may be virtualized and executed by remotely accessible, networked computing devices configured in a cloud-computing configuration. In such a case, these virtualized aspects are run on different physical logic processors of various different machines, it will be understood.

Non-volatile storage device 906 includes one or more physical devices configured to hold instructions executable by the processing circuitry 902 to implement the methods and processes described herein. When such methods and processes are implemented, the state of non-volatile storage device 906 may be transformed—e.g., to hold different data.

Non-volatile storage device 906 may include physical devices that are removable and/or built in. Non-volatile storage device 906 may include optical memory, semiconductor memory, and/or magnetic memory, or other mass storage device technology. Non-volatile storage device 906 may include nonvolatile, dynamic, static, read/write, read-only, sequential-access, location-addressable, file-addressable, and/or content-addressable devices. It will be appreciated that non-volatile storage device 906 is configured to hold instructions even when power is cut to the non-volatile storage device 906.

Volatile memory 904 may include physical devices that include random access memory. Volatile memory 904 is typically utilized by processing circuitry 902 to temporarily store information during processing of software instructions. It will be appreciated that volatile memory 904 typically does not continue to store instructions when power is cut to the volatile memory 904.

Aspects of processing circuitry 902, volatile memory 904, and non-volatile storage device 906 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via processing circuitry 902 executing instructions held by non-volatile storage device 906, using portions of volatile memory 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 908 may be used to present a visual representation of data held by non-volatile storage device 906. The visual representation may take the form of a graphical user interface (GUI). As the herein described methods and processes change the data held by the non-volatile storage device, and thus transform the state of the non-volatile storage device, the state of display subsystem 908 may likewise be transformed to visually represent changes in the underlying data. Display subsystem 908 may include one or more display devices utilizing virtually any type of technology. Such display devices may be combined with processing circuitry 902, volatile memory 904, and/or non-volatile storage device 906 in a shared enclosure, or such display devices may be peripheral display devices.

When included, input subsystem 910 may comprise or interface with one or more user-input devices such as a keyboard, mouse, touch screen, camera, or microphone.

When included, communication subsystem 912 may be configured to communicatively couple various computing devices described herein with each other, and with other devices. Communication subsystem 912 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 900 to send and/or receive messages to and/or from other devices via a network such as the Internet.

The following paragraphs provide additional description of the subject matter of the present disclosure. One example includes a computing system for implementing programming-by-example using a large language model, the computing system comprising: processing circuitry and memory storing instructions that, during execution, cause the processing circuitry to perform the steps of: receiving a query for generating a program in a programming language, wherein the query comprises example inputs and corresponding outputs; and generating the program using the large language model by: generating a prompt that comprises the example inputs and the corresponding outputs; refining the prompt by: generating a partial program with one or more initial lines of code based on a syntax of the programming language; executing the one or more initial lines of code to extract a plurality of variable values, wherein each of the plurality of variable values corresponds to a respective one of the example inputs; and storing, for each of the one or more initial lines of code, a text annotation describing the variable values for the example inputs; and autoregressively expanding the partial program by generating additional lines of code with corresponding text annotations in an iterative manner, wherein the additional lines of code are generated based on the syntax of the programming language, previously generated lines of code, and stored text annotations of the previously generated lines of code; and returning the partial program as the program when the partial program includes a function that returns a respective one of the example corresponding outputs for each of the example inputs. In this example, additionally or alternatively, each line of code of the one or more initial lines of code and the additional lines of code is generated by sampling code using one or more of: the LLM or a library of available functions in the programming language. In this example, additionally or alternatively, each line of code of the one or more initial lines of code and the additional lines of code is further generated by creating a new variable and assigning it to a value based on the sampled code. In this example, additionally or alternatively, the sample code includes an operation applied to one or more of the example inputs or the variable values in the text annotations to the lines of code in the partial program. In this example, additionally or alternatively, each of the additional lines of code is generated based on a respective one of the previously generated lines of code, and wherein the respective one of the previously generated lines of code is selected based on its estimated value. In this example, additionally or alternatively, generating the program using the LLM further comprises, before returning the partial program as the program, removing code from the partial program that is not used by the function. In this example, additionally or alternatively, refining the prompt further comprises canonicalizing the partial program based on the additional lines of code. In this example, additionally or alternatively, canonicalizing the partial program comprises removing a similar line of code. In this example, additionally or alternatively, canonicalizing the partial program comprises replacing one or more occurrences of a term in the lines of code of the partial program with a simplified form. In this example, additionally or alternatively, refining the prompt further comprises removing a line of code from the partial program based on a predetermined criterion of utilization of the line of code in the generation of the additional lines of code.

Another example includes a method for implementing programming-by-example using a large language model, the method comprising: receiving a query for generating a program in a programming language, wherein the query comprises example inputs and corresponding outputs; and generating the program using the large language model by: generating a prompt that comprises the example inputs and the corresponding outputs; refining the prompt by: generating a partial program with one or more initial lines of code based on a syntax of the programming language; for each of the one or more initial lines of code: executing the initial line of code to extract a plurality of variable values, wherein each of the plurality of variable values corresponds to a respective one of the example inputs; and storing the plurality of variable values in the partial program as a text annotation to the initial line of code; and autoregressively expanding the partial program by generating additional lines of code with corresponding text annotations in an iterative manner, wherein the additional lines of code for a given iteration are generated based on the syntax of the programming language, previously generated lines of code, and stored text annotations of the previously generated lines of code; and returning the partial program as the program when the partial program includes a function that returns a respective one of the example corresponding outputs for each of the example inputs or when the partial program has been expanded for a predetermined number of iterations. In this example, additionally or alternatively, each line of code of the one or more initial lines of code and the additional lines of code is generated by sampling code using one or more of: the LLM or a library of available functions in the programming language. In this example, additionally or alternatively, each of the additional lines of code is generated based on a respective one of the previously generated lines of code, and wherein the respective one of the previously generated lines of code is selected based on its estimated value. In this example, additionally or alternatively, generating the program using the LLM further comprises, before returning the partial program as the program, removing code from the partial program that is not used by the function. In this example, additionally or alternatively, refining the prompt further comprises canonicalizing the partial program based on the additional lines of code. In this example, additionally or alternatively, refining the prompt further comprises removing a line of code from the partial program based on a predetermined criterion of utilization of the line of code in the generation of the additional lines of code.

Another example includes method for implementing programming-by-example using a large language model (LLM), the computing system comprising: receiving a query for generating a program in a programming language, wherein the query comprises example inputs and corresponding outputs; generating the program using the LLM by: generating a prompt that comprises the example inputs and the corresponding outputs; refining the prompt by: generating a partial program with one or more initial lines of code by sampling from available functions of the programming language; executing the one or more initial lines of code based on the example inputs to generate a variable value for each of the example inputs; and iteratively expanding the partial program to generate additional lines of code with corresponding text annotations by sampling from the available functions of the programming language, wherein the additional lines of code are generated based on previously generated lines of code and corresponding variable values of the previously generated lines of code; and returning the partial program as the program when the partial program includes a function that returns a respective one of the example corresponding outputs for each of the example inputs. In this example, additionally or alternatively, sampling from the available functions of the programming language is performed using the LLM. In this example, additionally or alternatively, refining the prompt further comprises canonicalizing the partial program based on the additional lines of code. In this example, additionally or alternatively, refining the prompt further comprises removing a line of code from the partial program based on a predetermined criterion of utilization of the line of code in the generation of the additional lines of code.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for implementing programming-by-example using a large language model (LLM), the computing system comprising:
processing circuitry and memory storing instructions that, during execution, cause the processing circuitry to perform the steps of:
receiving a query for generating a program in a programming language, wherein the query comprises example inputs and corresponding outputs; and
generating the program using the LLM by:
generating a prompt that comprises the example inputs and the corresponding outputs;
refining the prompt by:
generating a partial program with one or more initial lines of code based on a syntax of the programming language;
executing the one or more initial lines of code to extract a plurality of variable values, wherein each of the plurality of variable values corresponds to a respective one of the example inputs;
storing, for each of the one or more initial lines of code, a text annotation describing the variable values for the example inputs; and
autoregressively expanding the partial program by generating additional lines of code with corresponding text annotations in an iterative manner, wherein the additional lines of code are generated based on the syntax of the programming language, previously generated lines of code, and stored text annotations the previously generated lines of code; and
returning the partial program as the program when the partial program includes a function that returns a respective one of the example corresponding outputs for each of the example inputs.

2. The computing system of claim 1, wherein each line of code of the one or more initial lines of code and the additional lines of code is generated by sampling code using one or more of: the LLM or a library of available functions in the programming language.

3. The computing system of claim 2, wherein each line of code of the one or more initial lines of code and the additional lines of code is further generated by creating a new variable and assigning it to a value based on the sampled code.

4. The computing system of claim 3, wherein the sample code includes an operation applied to one or more of the example inputs or the variable values in the text annotations to the lines of code in the partial program.

5. The computing system of claim 1, wherein each of the additional lines of code is generated based on a respective one of the previously generated lines of code, and wherein the respective one of the previously generated lines of code is selected based on its estimated value.

6. The computing system of claim 1, wherein generating the program using the LLM further comprises, before returning the partial program as the program, removing code from the partial program that is not used by the function.

7. The computing system of claim 1, wherein refining the prompt further comprises canonicalizing the partial program based on the additional lines of code.

8. The computing system of claim 7, wherein canonicalizing the partial program comprises removing a similar line of code.

9. The computing system of claim 7, wherein canonicalizing the partial program comprises replacing one or more occurrences of a term in the lines of code of the partial program with a simplified form.

10. The computing system of claim 1, wherein refining the prompt further comprises removing a line of code from the partial program based on a predetermined criterion of utilization of the line of code in the generation of the additional lines of code.

11. A method for implementing programming-by-example using a large language model (LLM), the method comprising:
receiving a query for generating a program in a programming language, wherein the query comprises example inputs and corresponding outputs; and
generating the program using the LLM by:
generating a prompt that comprises the example inputs and the corresponding outputs;
refining the prompt by:
generating a partial program with one or more initial lines of code based on a syntax of the programming language;
for each of the one or more initial lines of code:
executing the initial line of code to extract a plurality of variable values, wherein each of the plurality of variable values corresponds to a respective one of the example inputs; and
storing the plurality of variable values in the partial program as a text annotation to the initial line of code; and
autoregressively expanding the partial program by generating additional lines of code with corresponding text annotations in an iterative manner, wherein the additional lines of code for a given iteration are generated based on the syntax of the programming language, previously generated lines of code, and stored text annotations of the previously generated lines of code; and
returning the partial program as the program when the partial program includes a function that returns a respective one of the example corresponding outputs for each of the example inputs or when the partial program has been expanded for a predetermined number of iterations.

12. The method of claim 11, wherein each line of code of the one or more initial lines of code and the additional lines of code is generated by sampling code using one or more of: the LLM or a library of available functions in the programming language.

13. The method of claim 11, wherein each of the additional lines of code is generated based on a respective one of the previously generated lines of code, and wherein the respective one of the previously generated lines of code is selected based on its estimated value.

14. The method of claim 11, wherein generating the program using the LLM further comprises, before returning the partial program as the program, removing code from the partial program that is not used by the function.

15. The method of claim 11, wherein refining the prompt further comprises canonicalizing the partial program based on the additional lines of code.

16. The method of claim 11, wherein refining the prompt further comprises removing a line of code from the partial program based on a predetermined criterion of utilization of the line of code in the generation of the additional lines of code.

17. A method for implementing programming-by-example using a large language model (LLM), the computing system comprising:
receiving a query for generating a program in a programming language, wherein the query comprises example inputs and corresponding outputs;
generating the program using the LLM by:
generating a prompt that comprises the example inputs and the corresponding outputs;
refining the prompt by:
generating a partial program with one or more initial lines of code by sampling from available functions of the programming language;
executing the one or more initial lines of code based on the example inputs to generate a variable value for each of the example inputs; and
iteratively expanding the partial program to generate additional lines of code with corresponding text annotations by sampling from the available functions of the programming language, wherein the additional lines of code are generated based on previously generated lines of code and corresponding variable values of the previously generated lines of code; and
returning the partial program as the program when the partial program includes a function that returns a respective one of the example corresponding outputs for each of the example inputs.

18. The computing system of claim 17, wherein sampling from the available functions of the programming language is performed using the LLM.

19. The computing system of claim 17, wherein refining the prompt further comprises canonicalizing the partial program based on the additional lines of code.

20. The computing system of claim 17, wherein refining the prompt further comprises removing a line of code from the partial program based on a predetermined criterion of utilization of the line of code in the generation of the additional lines of code.
